(19) United States
(12) Patent Application Publication
(10) Pub. No.: US 2024/0282482 A1
(43) Pub. Date: Aug. 22, 2024

(54) WIRING MEMBER-EQUIPPED ADHEREND

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Daichi FUKUSHIMA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/293,391

(22) PCT Filed: Jun. 28, 2022
(86) PCT No.: PCT/JP2022/025732

§ 371 Date: Jan. 30, 2024

(30) Foreign Application Priority Data
Aug. 20, 2021 (JP) 2021-134730

(51) Int. Cl. H01B 7/40; B60R 16/02; H01B 3/50; H01B 7/08

(52) U.S. Cl. CPC H01B 7/40; B60R 16/0215; H01B 3/50; H01B 7/0838; H01B 7/0846

(57) ABSTRACT

A wiring member-equipped adherend includes: an adherend including an attached surface; a first sheet overlapped with the attached surface; a second sheet overlapped with the first sheet; a wire-like transmission member located between the first sheet and the second sheet; and an adhesive agent bonding the first sheet, the second sheet, and the adherend. The first surface of the first sheet is bonded to the attached surface via the first layer of the adhesive agent. A part of the second surface of the first sheet on a lateral side of the wire-like transmission member is bonded to the second sheet via the second layer of the adhesive agent penetrating the first sheet.

### TECHNICAL FIELD

The present disclosure relates to a wiring member-equipped adherend.

### BACKGROUND ART

Patent Document 1 discloses a technique of keeping a plurality of electrical wires flat. In Patent Document 1, the plurality of electrical wires are sandwiched by two sheets to be kept flat, for example.

### PRIOR ART DOCUMENTS

### Patent Document(s)

Patent Document 1: Japanese Patent Application Laid-Open No. 2019-202730

### SUMMARY

### Problem to be Solved by the Invention

A sheet of a wiring member described in Patent Document 1 is fixed to an adherend in some cases. It is desired that fixation of two sheets sandwiching a plurality of electrical wires and fixation of a sheet and an adherend are simply fixed to each other.

Accordingly, an object is to provide a technique capable of simply performing fixation of a plurality of sheets sandwiching a wire-like transmission member and fixation of a sheet and an adherend.

### Means to Solve the Problem

A wiring member-equipped adherend according to the present disclosure is a wiring member-equipped adherend including: an adherend including an attached surface; a first sheet overlapped with the attached surface; a second sheet overlapped with the first sheet; a wire-like transmission member located between the first sheet and the second sheet; and an adhesive agent bonding the first sheet, the second sheet, and the adherend, wherein a void reaching a second surface directed to the second sheet from a first surface directed to the attached surface is formed in the first sheet, the adhesive agent includes a first layer provided between the first surface and the attached surface and a second layer penetrating the first sheet from the first layer via the void, the first surface is bonded to the attached surface via the first layer, and a part of the second surface on a lateral side of the wire-like transmission member is bonded to the second sheet via the second layer.

### Effects of the Invention

According to the present disclosure, fixation of the plurality of sheets sandwiching the wire-like transmission member and fixation of the sheet and the adherend are simply performed.

### BRIEF DESCRIPTION OF DRAWINGS

FIG. 1 is a plan view illustrating a wiring member-equipped adherend according to an embodiment 1.

FIG. 2 is a schematic cross-sectional view along a II-II line in FIG. 1.

FIG. 3 is an enlarged view of a region A in FIG. 2.

FIG. 4 is a diagram illustrating manufacture of the wiring member-equipped adherend.

FIG. 5 is a diagram illustrating manufacture of the wiring member-equipped adherend.

FIG. 6 is a cross-sectional view illustrating a modification example of the wiring member-equipped adherend.

### DESCRIPTION OF EMBODIMENT(S)

### Description of Embodiment of Present Disclosure

Embodiments of the present disclosure are listed and described firstly.

A wiring member-equipped adherend according to the present disclosure is as follows.

(1) A wiring member-equipped adherend includes: an adherend including an attached surface; a first sheet overlapped with the attached surface; a second sheet overlapped with the first sheet; a wire-like transmission member located between the first sheet and the second sheet; and an adhesive agent bonding the first sheet, the second sheet, and the adherend, wherein a void reaching a second surface directed to the second sheet from a first surface directed to the attached surface is formed in the first sheet, the adhesive agent includes a first layer provided between the first surface and the attached surface and a second layer penetrating the first sheet from the first layer via the void, the first surface is bonded to the attached surface via the first layer, and a part of the second surface on a lateral side of the wire-like transmission member is bonded to the second sheet via the second layer. Fixation of the first sheet and the adherend and fixation of the first sheet and the second sheet are performed by the first layer and the second layer of the adhesive agent. Accordingly, fixation of the first sheet and the second sheet sandwiching the wire-like transmission member and fixation of the first sheet and the adherend are simply performed. The first layer forms a layer between the first sheet and the adherend, thus the first sheet and the adherend can be relatively rigidly fixed to each other.

(2) In the wiring member-equipped adherend according to (1), it is applicable that the first sheet includes a non-woven cloth layer, and the void of the first sheet is formed between a plurality of fibers in the non-woven cloth layer. Accordingly, the void of the first sheet is simply provided.

(3) In the wiring member-equipped adherend according to (1) or (2), it is applicable that a void reaching an inner portion of the second sheet from a third surface directed to the first sheet in the second sheet is formed in the second sheet, and the adhesive agent includes a third layer penetrating the second sheet via the void of the second sheet. Such a configuration causes anchor effect also on a side of the second sheet in fixation of the first sheet and the second sheet, and fixation strength is increased.

(4) In the wiring member-equipped adherend according to (3), it is applicable that the second sheet includes a non-woven cloth layer, and the void of the second sheet is formed between a plurality of fibers in the non-woven cloth layer. Accordingly, the void of the second sheet is simply provided.

(5) In the wiring member-equipped adherend according to (3) or (4), it is applicable that the void of the second sheet reaches a fourth surface of the second sheet facing a side opposite to the third surface from the third surface, and the adhesive agent does not reach the fourth surface. Accordingly, suppressed is exposure of the adhesive agent to the fourth surface of the second sheet.

(6) In the wiring member-equipped adherend according to any one of (1) to (5), the wire-like transmission member may be fixed to any one of the first sheet and the second sheet. Accordingly, when the first sheet and the second sheet sandwich the wire-like transmission member, the wire-like transmission member may hardly come out from between the first sheet and the second sheet. Accordingly, a fixing operation is easily performed.

(7) In the wiring member-equipped adherend according to any one of (1) to (6), the second sheet may be shorter than the first sheet along an extension direction of the wire-like transmission member. Accordingly, weight of the wiring member-equipped adherend can be reduced compared with a case where the second sheet has the same length as the first sheet along the extension direction of the wire-like transmission member.

(8) In the wiring member-equipped adherend according to (7), the wire-like transmission member may be fixed to the first sheet. Accordingly, the wire-like transmission member can be integrated with the first sheet over a wide range, and the first sheet provided with the wire-like transmission member can be easily handled.

### Detailed Description of Embodiment of Present Disclosure

Specific examples of a wiring member-equipped adherend according to the present disclosure are described hereinafter with reference to the drawings. The present disclosure is not limited to these examples, but is indicated by claims, and it is intended that meanings equivalent to claims and all modifications within a scope of claims are included.

### Embodiment 1

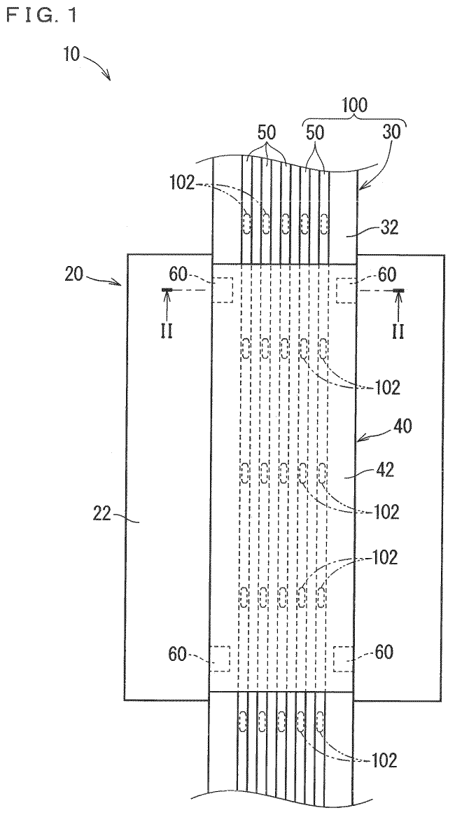

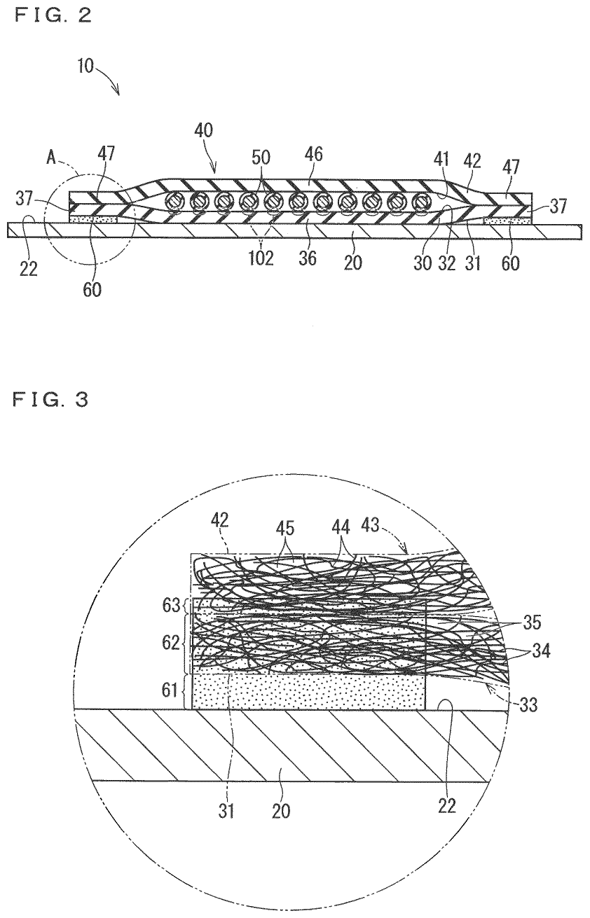

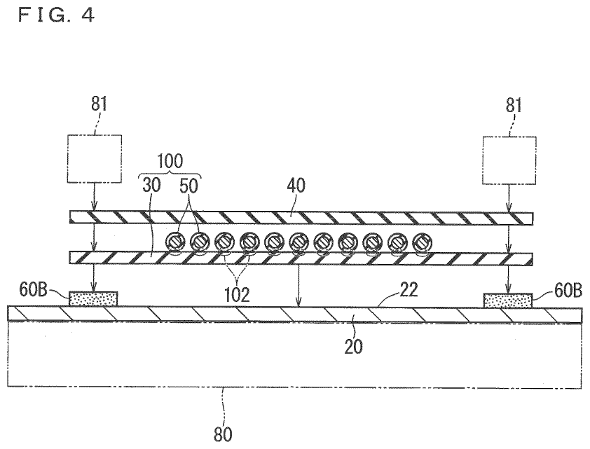

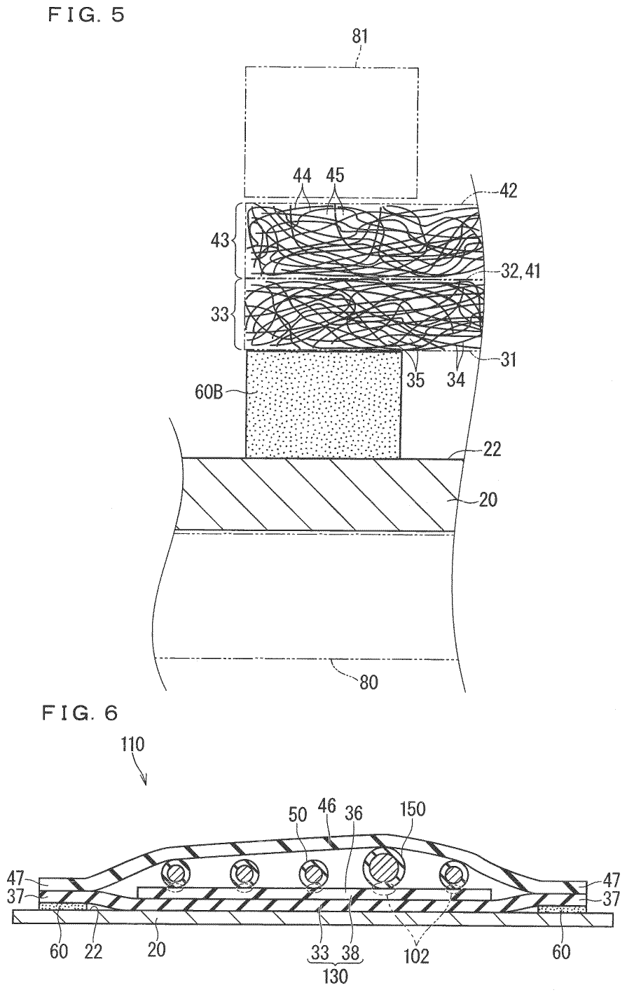

A wiring member-equipped adherend according to an embodiment 1 is described hereinafter. FIG. 1 is a plan view illustrating a wiring member-equipped adherend 10 according to the embodiment 1. FIG. 2 is a schematic cross-sectional view along a II-II line in FIG. 1. FIG. 3 is an enlarged view of the region A in FIG. 2. FIG. 4 and FIG. 5 are diagrams each illustrating manufacture of the wiring member-equipped adherend 10. FIG. 4 is a schematic cross-sectional view in a position similar to that in FIG. 2, and FIG. 5 is an enlarged view in a position similar to that in FIG. 3.

The wiring member-equipped adherend 10 includes an adherend 20, a first sheet 30, a second sheet 40, a wire-like transmission member 50, and an adhesive agent 60.

The adherend 20 is a member provided in a position where the wire-like transmission member 50 is disposed in a vehicle. In the example illustrated in FIG. 1, an intermediate portion of the wire-like transmission members 50 is disposed on the adherend 20. A first end portion of the wire-like transmission member 50 extends to an outer side from a first end portion of the adherend 20. A second end portion of the wire-like transmission member 50 extends to an outer side from a second end portion of the adherend 20. One of or both the first end portion and the second portion of the wire-like transmission member 50 may be disposed on the adherend 20.

The adherend 20 is a component provided to a vehicle. For example, the adherend 20 is a member provided to a vehicle later. The adherend 20 may be incorporated into the vehicle together with the wire-like transmission member 50. The adherend 20 and the wire-like transmission member 50 may be transported to a vehicle assembly plant in a state of the wiring member-equipped adherend 10. The adherend 20 may be a rigid member, for example. Each of the flexible first sheet 30, second sheet 40, and wire-like transmission member 50 may be fixed to the adherend 20, thereby being kept in a shape corresponding to the adherend 20.

The adherend 20 may be a bracket, for example. The adherend 20 may have the other function in addition to the function of fixing the wire-like transmission member 50. Such a function may be a function of fixing an apparatus, for example. The adherend 20 may be provided with a fixing part fixed to a vehicle. When the adherend 20 and the vehicle are fixed by a screw, the fixing part provided to the adherend 20 is preferably a part used for screwing, and may be a through hole, a screw hole, a nut, or a stud bolt, for example.

The adherend 20 may be a member previously assembled to a vehicle before the wire-like transmission member 50 is assembled to the vehicle. The adherend 20 and the wire-like transmission member 50 may be transported to a vehicle assembly plant separately from each other. For example, the adherend 20 may be a body panel or a body frame.

The adherend 20 includes an attached surface 22. The first sheet 30 is bonded to the attached surface 22 via the adhesive agent 60. Herein, the attached surface 22 is made of metal. The adherend 20 is a member including a metal member such as a single body of a metal member or a composite member of a metal member and a resin member, for example. A surface of this metal member serves as the attached surface 22. However, the attached surface 22 may be made of resin. In this case, the adherend 20 is a member including a resin member such as a single body of a resin member or a composite member of a metal member and a resin member, for example, and a surface of the resin member serves as the attached surface 22.

The first sheet 30 is overlapped with the attached surface 22. The first sheet 30 includes a first surface 31 and a second surface 32. The first surface 31 is a surface directed to the attached surface 22. The second surface 32 is a surface directed to the second sheet 40. A void 35 is formed in the first sheet 30. The void 35 reaches the second surface 32 from the first surface 31.

The first sheet 30 includes a non-woven cloth layer 33. The void 35 of the first sheet 30 is formed between a plurality of fibers 34 in the non-woven cloth layer 33. In the present example, the first sheet 30 has a single layer structure. The first sheet 30 includes only the non-woven cloth layer 33. The first sheet 30 may have a multilayer structure.

A part of the first sheet 30 serves as a cover part 36, and the other part thereof serves as a sheet fixing part 37. The cover part 36 is a part covering the wire-like transmission member 50. The sheet fixing part 37 is a part fixed to the second sheet 40. An intermediate portion of the first sheet 30 along a parallel direction of the wire-like transmission member 50 is the cover part 36 and both end portions thereof is the sheet fixing part 37.

The second sheet 40 is overlapped with the first sheet 30. The second sheet 40 includes a third surface 41 and a fourth surface 42. The third surface 41 is a surface directed to the first sheet 30. The fourth surface 42 is a surface directed to a side opposite to the third surface 41. A void 45 is formed in the second sheet 40. The void 45 reaches an inner portion of the second sheet 40 from the third surface 41. The void 45 reaches the fourth surface 42 from the third surface 41 herein.

The second sheet 40 includes a non-woven cloth layer 43. The void 45 of the second sheet 40 is formed between a plurality of fibers 44 in the non-woven cloth layer 43. In the present example, the second sheet 40 has a single layer structure. The second sheet 40 includes only the non-woven cloth layer 43. The second sheet 40 may have a multilayer structure.

A part of the second sheet 40 serves as a cover part 46, and the other part thereof serves as a sheet fixing part 47. The cover part 46 is a part covering the wire-like transmission member 50 from a side opposite to the cover part 36. The wire-like transmission member 50 is disposed between the cover parts 36 and 46. The sheet fixing part 47 is a part fixed to the first sheet 30. The sheet fixing parts 37 and 47 are fixed by the adhesive agent 60 while being in contact with each other. An intermediate portion of the second sheet 40 along the parallel direction of the wire-like transmission member 50 is the cover part 46 and both end portions thereof is the sheet fixing part 47.

The first sheet 30 is longer than the second sheet 40 along an extension direction of the wire-like transmission member 50. In the example illustrated in FIG. 1, the first sheet 30 is longer than the adherend 20. The first end portion of the first sheet 30 extends to an outer side from the first end portion of the adherend 20 together with the wire-like transmission member 50. The second end portion of the first sheet 30 extends to an outer side from the second end portion of the adherend 20 together with the wire-like transmission member 50. One of or both the first end portion and the second portion of the first sheet 30 may be disposed on the adherend 20.

The second sheet 40 is shorter than the first sheet 30 along the extension direction of the wire-like transmission member 50. In the example illustrated in FIG. 1, the second sheet 40 substantially has the same length as the adherend 20. A dimension along the extension direction of the wire-like transmission member 50 is larger than that along the parallel direction of the wire-like transmission member 50 in the second sheet 40. Both the first end portion and the second portion of the second sheet 40 are disposed on the adherend 20. The first end portion of the second sheet 40 is disposed on the first end portion of the adherend 20, and the second end portion of the second sheet 40 is disposed on the second end portion of the adherend 20. One of or both the first end portion and the second portion of the second sheet 40 may extend to an outer side from the end portion of the adherend 20.

The second sheet 40 may be formed to have a small length along the extension direction of the wire-like transmission member 50 to be provided in a plurality of positions at intervals on the adherend 20. A dimension along the extension direction of the wire-like transmission member 50 may be smaller than that along the parallel direction of the wire-like transmission member 50 in the second sheet 40, for example.

The fibers 34 and 44 in the non-woven cloth layers 33 and 43 may be a synthesized fiber or a natural fiber. The synthesized fiber may be made of resin. A type of the resin is not particularly limited, but polyethylene terephthalate (PET), polyvinyl chloride (PVC), polyethylene (PE), or polypropylene (PP), can be adopted, for example. A non-woven cloth of the non-woven cloth layer 33 and a non-woven cloth of the non-woven cloth layer 43 may be the same type or different types of cloth. A material, a thickness, or a weight per area, for example, may be different as two different types of non-woven cloth.

The wire-like transmission member 50 is a wire-like member transmitting electricity or light, for example. One or a plurality of wire-like transmission members 50 are provided. The wire-like transmission member 50 is assumed to be a member connecting components in a vehicle. A connector, for example, is provided to an end portion of the wire-like transmission member 50. This connector is connected to a connector provided to the other side component, thus the wire-like transmission member 50 is connected to the other side component. The connector may be fixed to the first sheet 30. The connector may be provided to an outer side of the first sheet 30.

The wire-like transmission member 50 includes a transmission wire body 51 and a covering layer 52. The transmission wire body 51 is a transmission route transmitting electricity or light. For example, when the wire-like transmission member 50 is an electrical wire, the transmission wire body 51 is a conductor core wire. The conductor core wire is made up of one or a plurality of strands. The strand is formed of copper, copper alloy, aluminum, or aluminum alloy as a material, for example. For example, when the wire-like transmission member 50 is an optical fiber, the transmission wire body 51 is a core and a clad. The covering layer 52 is a layer covering the transmission wire body 51. A resin material constituting the covering layer 52 is not particularly limited, but can be appropriately set. For example, the wire-like transmission member 50 may be a general wire having a core wire and a covering layer 52 around the core wire, or may also be a shield wire, a twisted wire, an enamel wire, a nichrome wire, or an optical fiber.

The wire-like transmission member 50 transmitting the electricity may be various kinds of signal lines or various kinds of power lines. Some of the wire-like transmission members 50 transmitting the electricity may be used as an antenna or coil, for example, transmitting or receiving a signal or electrical power to or from a space.

The wire-like transmission member 50 may be a single core wire. The single core wire is a single wire-like object. The single core wire is the wire-like transmission member 50 with one transmission route. The wire-like transmission member 50 may be a multicore wire. The multicore wire is a compound body of a plurality of wire-like objects. The multicore wire is the wire-like transmission member 50 with a plurality of transmission routes. The multicore wire may be a cable made up of collected twisted wires or a plurality of wire-like objects covered by a sheath, for example.

The wire-like transmission member 50 is located between the first sheet 30 and the second sheet 40. The wire-like transmission member 50 is fixed to any one of the first sheet 30 and the second sheet 40. In the present example, the wire-like transmission member 50 is fixed to the first sheet 30. In the description hereinafter, the first sheet 30 and the wire-like transmission member 50 integrated with each other are referred to as a wiring body 100. The wiring body 100 is used as a wiring member electrically connecting various types of component in a vehicle, for example (or connecting them so that they can perform optical communication).

The first sheet 30 and the wire-like transmission member 50 are partially fixed to each other along the extension direction of the wire-like transmission member 50. The fixing part thereof is referred to as a spot fixing part 102. The plurality of spot fixing parts 102 are provided at intervals along the extension direction of the wire-like transmission member 50. The interval between the spot fixing parts 102 is not particularly limited, but can be appropriately set. However, the fixing part between the first sheet 30 and the wire-like transmission member 50 needs not be the spot fixing part 102. The fixing part between the first sheet 30 and the wire-like transmission member 50 may be continuously provided to have a large length along the extension direction of the wire-like transmission member 50.

Any fixing state may be applied as a fixing state in the spot fixing part 102 between the first sheet 30 and the wire-like transmission member 50. Applicable as the fixing state are a contact area fixation and a non-contact area fixation, or both fixations may be used together. Herein, the contact area fixation indicates that a portion where the first sheet 30 and the wire-like transmission member 50 have contact with each other is stuck and fixed. The non-contact area fixation is a fixing state which is not the contact area fixation, and indicates that a sewing thread, a cover, or an adhesive tape presses the wire-like transmission member 50 toward the first sheet 30 or sandwiches the first sheet 30 and the wire-like transmission member 50 to keep them in a fixing state. In the description hereinafter, the first sheet 30 and the wire-like transmission member 50 are in the state of the contact area fixation.

Applicable as the configuration of the contact area fixation are a contact area indirect fixation and a contact area direct fixation, or both fixations may also be used together in different regions. Herein, the contact area indirect fixation indicates that the first sheet 30 and the wire-like transmission member 50 are indirectly stuck and fixed via an adhesive member such as an adhesive agent, a gluing agent, and a double-sided adhesive tape provided therebetween. The contact area direct fixation indicates that the first sheet 30 and the wire-like transmission member 50 are directly stuck and fixed without an intervention of the adhesive agent, for example, which is separately provided. Considered in the contact area direct fixation is that resin included in at least one of the first sheet 30 and/or the wire-like transmission member 50 is melted, thus the first sheet 30 and the wire-like transmission member 50 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as welding, fusion, and melting joint can be used. Herein, in the spot fixing part 102 between the first sheet 30 and the wire-like transmission member 50, the first sheet 30 and the wire-like transmission member 50 are fused to each other. In the present example, the non-woven cloth layer 33 of the first sheet 30 and an outermost layer of the wire-like transmission member 50 are fused to each other. The outermost layer of the wire-like transmission member 50 is the covering layer 52.

A route of the wire-like transmission member 50 is set in accordance with a position of a component to which the wire-like transmission member 50 is connected, for example. The wire-like transmission members 50 are fixed to the first sheet 30, thus the wire-like transmission members 50 are kept in a form following a wiring route corresponding to a position of a component as a connection destination of each wire-like transmission member 50. Herein, the wire-like transmission members 50 extend straight on the first sheet 30. The first sheet 30 is formed into a shape in accordance with a route of the wire-like transmission member 50 (straight shape, herein). However, the route of the wire-like transmission members 50 may be made up of a combination of a straight route and a bending route. The first sheet 30 may also be made up of a combination of a straight route and a bending route. The plurality of wire-like transmission members 50 may be fixed to the first sheet 30 in a state where a branch wire is branched from a main wire. The first sheet 30 may also be formed into a shape in which a part to which the branch wire is fixed is branched from a part to which the main wire is fixed.

The first sheet 30 and the second sheet 40 may be flexible members. For example, the first sheet 30 and the second sheet 40 are non-woven clothes having flexibility, and are flexible members. For example, the first sheet 30 may have flexibility so as to be able to follow bending of the wire-like transmission member 50. It is also applicable that the first sheet 30 and the wire-like transmission member 50 can be bended in a thickness direction (bending so that a fold line follows a main surface of the first sheet 30).

The adhesive agent 60 bonds the adherend 20, the first sheet 30, and the second sheet 40. The adhesive agent 60 includes a first layer 61 and a second layer 62. The adhesive agent 60 further includes a third layer 63. The first layer 61 is provided between the first surface 31 and the attached surface 22. The second layer 62 penetrates the first sheet 30 from the first layer 61 via the void 35. The third layer 63 penetrates the second sheet 40 from the second layer 62 via the void 45. The adhesive agent 60 penetrating an inner portion of the second sheet 40 does not reach the fourth surface 42.

The first surface 31 is bonded to the attached surface 22 via the first layer 61. The first surface 31 does not have contact with the attached surface 22 in the sheet fixing part 37 of the first sheet 30. The first surface 31 is located away from the attached surface 22 by a thickness of the first layer 61 in the sheet fixing part 37 of the first sheet 30. The adhesive agent 60 is not provided to a portion of the cover part 36 herein. The first surface 31 has contact with the attached surface 22 in the cover part 36 of the first sheet 30. The adhesive agent 60 may also be provided to a portion of the cover part 36.

A part of the second surface 32 on a lateral side of the wire-like transmission member 50 is bonded to the second sheet 40 via the second layer 62. The second surface 32 is bonded to the second sheet 40 via the second layer 62 in the sheet fixing part 37 of the first sheet 30. At this time, the third layer 63 penetrating the second sheet 40 is located, thus fixation strength between the second sheet 40 and the adhesive agent 60 is increased.

The second surface 32 and the third surface 41 have contact with each other in a part except for the voids 35 and 45. The second surface 32 and the third surface 41 are bonded to each other via the second layer 62 and the third layer 63 penetrating the voids 35 and 45.

Some fibers 34 of the first sheet 30 and some fibers 44 of the second sheet 40 have contact with each other. The adhesive agent 60 of the second layer 62 and the third layer 63 covers around the fibers 34 and 44 having contact with each other.

A type of the adhesive agent 60 is not particularly limited, however, any type is applicable as long as the adhesive agent 60 is heated and softened to be able to have flowability. The adhesive agent 60 may be a hot-melt adhesive agent, for example.

A thickness of the first layer 61 is not particularly limited, but can be appropriately set. For example, the thickness of the first layer 61 may be the same as that of the sheet fixing part 37 of the first sheet 30, or may also be larger or smaller than that thereof. For example, the thickness of the first layer 61 may be 0.1 mm to 2 mm.

The second layer 62 penetrates the second surface 32 from the first surface 31 in the sheet fixing part 37. The second layer 62 penetrates the whole first sheet 30 in a thickness direction in the sheet fixing part 37. Thus, the thickness of the second layer 62 is the same as that of the sheet fixing part 37 of the first sheet 30. The thickness of the sheet fixing part 37 of the first sheet 30 may be the same as or different from that of the cover part 36. A non-woven cloth having a uniform thickness may be used as the non-woven cloth layer 33 of the first sheet 30. It is also applicable that this non-woven cloth is compressed when being bonded and fixed to the adherend 20 and the second sheet 40, and the sheet fixing part 37 has a smaller thickness than the cover part 36.

The third layer 63 does not penetrate the fourth surface 42 from the third surface 41 in the sheet fixing part 47. The third layer 63 penetrates a part of the sheet fixing part 47 along the thickness direction of the second sheet 40. Thus, the thickness of the third layer 63 is smaller than that of the sheet fixing part 47 of the second sheet 40. The thickness of the third layer 63 may be equal to or larger than 1/4 and equal to or smaller than 3/4 of the thickness of the sheet fixing part 47 of the second sheet 40, for example.

In the example illustrated in FIG. 1, the adhesive agent 60 is partially provided along the extension direction of the wire-like transmission member 50. The adhesive agent 60 is provided in a plurality of positions at intervals along the extension direction of the wire-like transmission member 50. The adhesive agent 60 is provided to the first end portion and the second end portion of the adherend 20. The adhesive agent 60 is not provided between the first end portion and the second end portion of the adherend 20. The adhesive agent 60 may be provided between the first end portion and the second end portion of the adherend 20. The adhesive agent 60 may be continuously provided between the first end portion and the second end portion of the adherend 20.

### <Manufacturing Method>

A method of manufacturing the wiring member-equipped adherend 10 is described next.

As illustrated in FIG. 4, a sheet-like hot-melt adhesive agent (referred to as an adhesive agent sheet 60B hereinafter) before being heated is provided on the attached surface 22. The first sheet 30 and the second sheet 40 are provided on the adhesive agent sheet 60B. The wire-like transmission member 50 is provided between the first sheet 30 and the second sheet 40. In the example illustrated in FIG. 4, the first sheet 30 and the wire-like transmission member 50 are integrally provided to be the wiring body 100. A bonded part is pressed by press members 80 and 81 while the first sheet 30 and the second sheet 40 are overlapped with each other so that the second surface 32 and the third surface 41 have contact with each other, and the adhesive agent sheet 60B is heated. At this time, one of or both the press members 80 and 81 may double as a heating member. The heating member may be provided separately from the press members 80 and 81. A method of heating the adhesive agent sheet 60B is not particularly limited, but can be appropriately set.

When the adhesive agent sheet 60B is heated, the adhesive agent is softened over time and has flowability. The adhesive agent having flowability penetrates an inner portion of the first sheet 30 from the first surface 31 via the void 35 to reach the second surface 32. Furthermore, the adhesive agent having flowability penetrates an inner portion of the second sheet 40 from the third surface 41 having contact with the second surface 32 via the void 45. At this time, the adhesive agent has stickiness so as to be able to pass through the first sheet 30 while having flowability and further penetrate the inner portion of the second sheet 40. The adhesive agent has stickiness so as to be able to be left between the attached surface 22 and the first surface 31 while having flowability.

The wiring member-equipped adherend 10 described above is completed while the adhesive agent penetrating the inner portion of the second sheet 40 does not reach the fourth surface 42. For example, the adhesive agent penetrating the inner portion of the second sheet 40 can be prevented from reaching the fourth surface 42 by adjusting a heating time or pressure of the press member.

### <Effect etc.>

According to the wiring member-equipped adherend 10 having the above configuration, fixation of the first sheet 30 and the adherend 20 and fixation of the first sheet 30 and the second sheet 40 are performed by the first layer 61 and the second layer 62 of the adhesive agent 60. Accordingly, fixation of the first sheet 30 and the second sheet 40 sandwiching the wire-like transmission member 50 and fixation of the first sheet 30 and the adherend 20 are simply performed. The first layer 61 forms the layer between the first sheet 30 and the adherend 20, thus the first sheet 30 and the adherend 20 can be relatively rigidly fixed to each other. The second layer 62 is the layer penetrating the first sheet 30, thus the adhesive agent 60 is rigidly fixed to the first sheet 30 by anchor effect.

For example, the second layer 62 can be formed by the adhesive agent sheet 60B between the first sheet 30 and the adherend 20 softened and penetrating the first sheet 30. Accordingly, fixation of the first sheet 30 and the adherend 20 and fixation of the first sheet 30 and the second sheet 40 can be performed by one fixing operation.

The first sheet 30 includes the non-woven cloth layer 33, and the void 35 of the first sheet 30 is formed between the plurality of fibers 34 in the non-woven cloth layer 33. Accordingly, the void 35 of the first sheet 30 is simply provided.

The void 45 reaching the inner portion of the second sheet 40 from the third surface 41 of the second sheet 40 directed to the first sheet 30 is formed in the second sheet 40, and the adhesive agent 60 includes the third layer 63 penetrating the second sheet 40 via the void 45 of the second sheet 40. Such a configuration causes anchor effect also on the second sheet 40 in fixation of the first sheet 30 and the second sheet 40 via the adhesive agent 60, and fixation strength is increased.

The second sheet 40 includes the non-woven cloth layer 43, and the void 45 of the second sheet 40 is formed between the plurality of fibers 44 in the non-woven cloth layer 43. Accordingly, the void 45 of the second sheet 40 is simply provided.

The void 45 of the second sheet 40 reaches the fourth surface 42 of the second sheet 40 directed to the side opposite to the third surface 41 from the third surface 41, and the adhesive agent 60 does not reach the fourth surface 42. Accordingly, suppressed is exposure of the adhesive agent 60 to the fourth surface 42 of the second sheet 40. Adhesion of the adhesive agent 60 to the press member 81 is suppressed.

The wire-like transmission member 50 is fixed to any one of the first sheet 30 and the second sheet 40. Accordingly, when the first sheet 30 and the second sheet 40 sandwich the wire-like transmission member 50, the wire-like transmission member 50 hardly comes out from between the first sheet 30 and the second sheet 40. Accordingly, a fixing operation is easily performed.

The second sheet 40 is shorter than the first sheet 30 along the extension direction of the wire-like transmission member 50. Accordingly, weight of the wiring member-equipped adherend 10 can be reduced compared with the case where the second sheet 40 has the same length as the first sheet 30 along the extension direction of the wire-like transmission member 50. At this time, the wire-like transmission member 50 is fixed to the first sheet 30. Accordingly, the wire-like transmission member 50 can be integrated with the first sheet 30 over a wide range, and the first sheet 30 provided with the wire-like transmission member 50 can be easily handled.

### Appendix

FIG. 6 is a cross-sectional view illustrating a modification example of the wiring member-equipped adherend 10. A wiring member-equipped adherend 110 illustrated in FIG. 6 is different from the wiring member-equipped adherend 10 described above in that a first sheet 130 has a multilayer structure. The first sheet 130 has a double layer structure of the non-woven cloth layer 33 and a fusion layer 38.

The fusion layer 38 is stacked closer to the wire-like transmission member 50 in relation to the non-woven cloth layer 33. The fusion layer 38 and the wire-like transmission member 50 are fused and fixed to each other. The fusion layer 38 is the layer more suitable for fixation to the wire-like transmission member 50 than the non-woven cloth layer 33. Accordingly, fixation strength of the spot fixing part 102 is increased, and the spot fixing part 102 hardly comes out from a wire-like transmission member 150 even having a large thickness, for example. The fusion layer 38 includes a resin material, or preferably includes a thermoplastic resin material. The resin material of the fusion layer 38 is softened and fused to a fusion target. The resin material is not particularly limited, however, the above resin material described for the material of the non-woven cloth layer 33 can be used, for example. It is preferable that a material of the covering layer 52 and a material of the fusion layer 38 have compatibility. Herein, a resin material constituting the covering layer 52 and a resin material constituting the fusion layer 38 are the same type of material. A resin material constituting the fusion layer 38 and a resin material constituting the covering layer 52 are PVC or polyolefin, for example.

The fusion layer 38 is a non-fibrous material sheet. The non-fibrous material sheet is a sheet which does not have a fiber. The fusion layer 38 may be a sheet having an evenly filled cross-sectional surface (also referred to as a non-foam sheet or a solid sheet, for example). The fusion layer 38 may also be a foam sheet, for example.

The fusion layer 38 is partially stacked to the non-woven cloth layer 33. The fusion layer 38 is provided to the cover part 36, and is not provided to the sheet fixing part 37 in the first sheet 130. A surface of the fusion layer 38 constitutes the second surface 32 in the cover part 36. A surface of the non-woven cloth layer 33 constitutes the second surface 32 in the sheet fixing part 37. Accordingly, the void 35 can reach the second surface 32 also in the first sheet 30 having the multilayer structure of the non-woven cloth layer 33 and the fusion layer 38. Accordingly, fixation of the first sheet 130 and the adherend 20 via the adhesive agent 60 and fixation of the first sheet 130 and the second sheet 40 can be performed also in the wiring member-equipped adherend 110 in the manner similar to the wiring member-equipped adherend 10.

The fusion layer 38 and the non-woven cloth layer 33 are fixed to each other while the surface of the fusion layer 38 and the surface of the non-woven cloth layer 33 have contact with each other. A fixing state of the fusion layer 38 and the non-woven cloth layer 33 is not particularly limited, however, fixing by fusion or adhesion is preferable. The non-woven cloth layer 33 includes the void 35, thus the resin material or the adhesive agent of the fusion layer 38 can enter the void 35 and can be fixed thereto. Such a configuration causes so-called anchor effect, thus the fusion layer 38 and the non-woven cloth layer 33 are rigidly fixed. In the description herein, the fusion layer 38 and the non-woven cloth layer 33 are fused to each other. That is to say, the resin of the fusion layer 38 enters between the fibers 34 of the non-woven cloth layer 33 while having flowability, and is then hardened. Accordingly, a state where the resin of the fusion layer 38 enters between the fibers 34 of the non-woven cloth layer 33 is maintained, and the fusion layer 38 and the non-woven cloth layer 33 are rigidly fixed.

Moreover, in the above description, the first sheet 30 includes the non-woven cloth layer 33, and the void 35 of the first sheet 30 is formed between the plurality of fibers 34 in the non-woven cloth layer 33, however, this configuration is not necessary. For example, the first sheet may be a fibrous material sheet different from a non-woven cloth such as a woven fabric or a braided fabric. In this case, a space between threads constituting the woven fabric or the braided fabric serves as a void of the first sheet. For example, the first sheet may be a continuous foam resin sheet. In this case, continuous foams in the continuous foam resin sheet serve as a void of the first sheet.

In the above description, the void 45 reaching the inner portion of the second sheet 40 from the third surface 41 of the second sheet 40 directed to the first sheet 30 is formed in the second sheet 40, and the adhesive agent 60 includes the third layer 63 penetrating the second sheet 40 via the void 45 of the second sheet 40, however, this configuration is not necessary. For example, the second sheet 40 may be a solid sheet without the void 45. The void 45 of the second sheet 40 may be formed only in a position where the adhesive agent 60 is not located.

Moreover, in the above description, the second sheet 40 is the non-woven cloth layer 43, and the void 45 of the second sheet 40 is formed between the plurality of fibers 44 in the non-woven cloth layer 43, however, this configuration is not necessary. For example, the second sheet may be a fibrous material sheet different from a non-woven cloth such as a woven fabric or a braided fabric. In this case, a space between threads constituting the woven fabric or the braided fabric serves as a void of the second sheet. For example, the second sheet may be a foam resin sheet. In this case, foams in the foam resin sheet serve as a void of the second sheet. The foam resin sheet may be a continuous foam resin sheet or a closed foam resin sheet. In the case of the continuous foam resin sheet, the foam as the void reaches the fourth surface from the third surface. In the case of the closed foam resin sheet, a part of the closed foam serves as a void opened on a side of the third surface in the second sheet, and the adhesive agent from the second layer can enter the void, however, the adhesive agent cannot physically reach the fourth surface by reason that the void does not reach the fourth surface.

In the above description, the void 45 of the second sheet 40 reaches the fourth surface 42 of the second sheet 40 directed to the side opposite to the third surface 41 from the third surface 41, and the adhesive agent 60 does not reach the fourth surface 42, however, this configuration is not necessary. For example, the adhesive agent 60 may reach the fourth surface 42 of the second sheet 40. For example, the void of the second sheet may not reach the fourth surface from the third surface. The closed foam resin sheet can be used as the second sheet in this case.

In the above description, the wire-like transmission member 50 is fixed to any one of the first sheet 30 and the second sheet 40, however, this configuration is not necessary. The wire-like transmission member 50 may not be fixed to any one of the first sheet 30 and the second sheet 40. In this case, a process of fixing the first sheet 30 or the second sheet 40 to the wire-like transmission member 50 can be omitted.

In the above description, the second sheet 40 is shorter than the first sheet 30 along the extension direction of the wire-like transmission member 50, however, this configuration is not necessary. For example, the second sheet 40 may have the same size as the first sheet 30. In the above description, at this time, the wire-like transmission member 50 is fixed to the first sheet 30, however, this configuration is not necessary. For example, the wire-like transmission member 50 may be fixed to the second sheet 40.

The configurations described in the embodiments and modification examples thereof can be appropriately combined as long as they are not contradictory.

### EXPLANATION OF REFERENCE SIGNS

10, 110 wiring member-equipped adherend
20 adherend
22 attached surface
30, 130 first sheet
31 first surface
32 second surface
33 non-woven cloth layer
34 fiber
35 void
36 cover part
37 sheet fixing part
38 fusion layer
40 second sheet
41 third surface
42 fourth surface
43 non-woven cloth layer
44 fiber
45 void
46 cover part
47 sheet fixing part
50 wire-like transmission member
51 transmission wire body
52 covering layer
60 adhesive agent
60B adhesive agent sheet
61 first layer
62 second layer
63 third layer
80, 81 press member
100 wiring body
102 spot fixing part

1. A wiring member-equipped adherend, comprising:
an adherend including an attached surface;
a first sheet overlapped with the attached surface;
a second sheet overlapped with the first sheet;
a wire-like transmission member located between the first sheet and the second sheet; and
an adhesive agent bonding the first sheet, the second sheet, and the adherend, wherein
a void reaching a second surface directed to the second sheet from a first surface directed to the attached surface is formed in the first sheet,
the adhesive agent includes a first layer provided between the first surface and the attached surface and a second layer penetrating the first sheet from the first layer via the void,
the first surface is bonded to the attached surface via the first layer, and
a part of the second surface on a lateral side of the wire-like transmission member is bonded to the second sheet via the second layer.

2. The wiring member-equipped adherend according to claim 1, wherein
the first sheet includes a non-woven cloth layer, and the void of the first sheet is formed between a plurality of fibers in the non-woven cloth layer.

3. The wiring member-equipped adherend according to claim 1, wherein
a void reaching an inner portion of the second sheet from a third surface directed to the first sheet in the second sheet is formed in the second sheet, and
the adhesive agent includes a third layer penetrating the second sheet via the void of the second sheet.

4. The wiring member-equipped adherend according to claim 3, wherein
the second sheet includes a non-woven cloth layer, and the void of the second sheet is formed between a plurality of fibers in the non-woven cloth layer.

5. The wiring member-equipped adherend according to claim 3, wherein
the void of the second sheet reaches a fourth surface of the second sheet facing a side opposite to the third surface from the third surface, and
the adhesive agent does not reach the fourth surface.

6. The wiring member-equipped adherend according to claim 1, wherein
the wire-like transmission member is fixed to any one of the first sheet and the second sheet.

7. The wiring member-equipped adherend according to claim 1, wherein
the second sheet is shorter than the first sheet along an extension direction of the wire-like transmission member.

8. The wiring member-equipped adherend according to claim 7, wherein
the wire-like transmission member is fixed to the first sheet.
